(19) United States
(12) Patent Application Publication
(10) Pub. No.: US 2013/0202908 A1
(43) Pub. Date: Aug. 8, 2013

(54) EQUIPMENT FOR USE IN CORROSIVE ENVIRONMENTS AND METHODS FOR FORMING THEREOF

(71) Applicants: Grzegorz Jan Kusinski, Moraga, CA (US); Edwin Hall Niccolls, Danville, CA (US); David Lawrence Cooke, San Rafael, CA (US)

(72) Inventors: Grzegorz Jan Kusinski, Moraga, CA (US); Edwin Hall Niccolls, Danville, CA (US); David Lawrence Cooke, San Rafael, CA (US)

(21) Appl. No.: 13/763,238

(22) Filed: Feb. 8, 2013

Related U.S. Application Data
(60) Provisional application No. 61/596,711, filed on Feb. 8, 2012.

(51) Int. Cl. F16L 9/02; B23P 15/00

(52) U.S. Cl. CPC F16L 9/02; B23P 15/00
USPC 428/544; 29/592

(57) ABSTRACT

Corrosion resistant structural equipment, e.g., steel pipe, for use in CO₂ containing environments having a corrosion rate of less than 40 mpy upon exposure to formation water and under CO₂ partial pressure of 0.5 MPa at a temperature of 40° C. The pipe complies with prevailing industry standards with respect to design, fabrication, inspection and testing, metallurgical and mechanical properties. The pipe is fabricated out of a carbon steel material with a Si content of 0.5 to 3.5% for CO₂ corrosion protection. In one embodiment, the material is carbon steel with a carbon equivalent (CE) of less than 0.63, requiring no post weld heat treatment (PWHT). In another embodiment, the CE is less than 0.45 requiring no preheat treatment nor PWHT.

### CROSS-REFERENCE TO RELATED APPLICATIONS

This application claims benefit under 35 USC 119 of U.S. Provisional Patent Application No. 61/596,711 with a filing date of Feb. 8, 2012.

### TECHNICAL FIELD

The invention relates generally to structural components such as piping systems, pressure vessels, and the like, for use in CO₂ corrosive environments, and methods for forming such structural components.

### BACKGROUND

In the petroleum industry, as shallow and less corrosive oil wells deplete, deeper drilling is needed wherein equipment is exposed to gaseous mixtures of carbon oxide and hydrogen sulfide. It is known that CO₂ in oil and gas production and transport lines is conducive to corrosion in mild steel pipeline, particularly in the presence of organic acids, e.g., acetic acid. Solutions containing acetic acids are known to be even more corrosive than solutions of strong acids such as HCl and H₂SO₄. CO₂ corrosion has gained more attention in the industry because of the technique of CO₂ injection for enhanced oil recovery and exploitation of deep natural gas reservoirs containing carbon dioxide. The presence of carbon dioxide, hydrogen sulphide (H₂S) and free water can cause severe corrosion problems in oil and gas pipelines. Internal corrosion in wells and pipelines is influenced by temperature, CO2 and H2S content, water chemistry, flow velocity, oil or water.

To mitigate the consequences of corrosion, current approaches generally involve either using equipment made of expensive, highly alloyed metals known as “corrosion resistant alloys” (CRAs) or using inexpensive carbon steels coupled with additional corrosion control measures including inspections, coatings, inhibition, cathodic protection, periodic repair/replacement. Typical CRA compositions derive their corrosion resistance from large alloying additions, such as chromium (Cr), exceeding about 12-13 wt %. This amount of chromium, e.g. 13 wt % Cr, is the minimum amount needed to form a complete surface coverage of nanometer thick passive film for the corrosion protection, see ASM Handbook, vol. 13A: corrosion 2003 Ed. p. 697; and Corrosion of Stainless Steels, A. J. Sedriks, p. 1 and FIG. 1.1 (Wiley, 1996). In fact, compositions having iron (Fe)-13 wt % Cr is the basic composition of the lowest cost CRA, which is often referred to as 13Cr steels. Additionally, the higher classes of CRAs contain not only more chromium, but also more of other more expensive alloying elements, such as molybdenum (Mo), to further improve their passive film performance, and resulting in even higher material costs.

Development work has shown that small quantities of chromium (0.5 to 3 wt. %) can offer improved corrosion resistance of low alloy steels in CO₂ containing media by promoting the formation of a stable protective chromium oxide film. In U.S. Pat. No. 6,248,187, an alloy steel for CO₂ corrosion resistant applications is disclosed with 2.1 to 5 wt. % Cr, wherein Si is added for oxidation purpose but only of up to 1% as “low temperature toughness is deteriorated” at a higher Si content.

There is still a need for a new class of materials, particularly low cost materials, for equipment subject to corrosion in CO₂ containing environments.

### SUMMARY OF THE INVENTION

In one aspect, the invention relates to a corrosion resistant pipe for use in a CO₂ corrosion environment. The pipe comprises a carbon steel composition based on weight: up to 0.35% of C; from 0.50 to 3.5% Si; up to 0.15% Mo; up to 1.35% Mn; up to 5% Al; one or more elements selected from Cr, Cu, Ni, and Cr in an amount of less than 0.4% each; a total concentration of Cr, Cu, Mo, Ni, and V of up to 1%; balance of Fe and unavoidable impurities. The pipe complies with at least one of ASTM and API standards with respect to manufacture, dimensions and weight, mechanical properties, testing, and certification. The pipe has a corrosion rate of at most 40 mpy upon exposure to formation water and under CO₂ partial pressure ranging from 0.5 to 1.5 MPa at a temperature of 40° C. In one embodiment, the pipe comprises a carbon steel composition having 0.5% to 1.5% Si by weight. In another embodiment, the pipe comprises a carbon steel composition having a carbon equivalent (“CE”) of less than 0.63 requiring no post weld heat treatment (PWHT). In another embodiment, the CE is less than 0.45 requiring no pre-heat treatement nor PWHT.

In another aspect, the pipe comprises a steel composition having chemical requirements as specified according to at least one of ASTM and API standards, modified by adding at least 0.25% Si to the chemical requirements for a Si content ranging from 0.50 to 3.5% by weight. The pipe complies to the at least one of ASTM and API standards with respect to manufacture, dimensions and weight, mechanical properties, testing, and certification. Upon exposure to formation water and under CO₂ partial pressure ranging from 0.5 to 1.5 MPa at a temperature of 40° C., the pipe has a corrosion rate of at least 25% less than a pipe having chemical requirements as specified according to the at least one of ASTM and API standards and without addition to the chemical requirements for Si. In one embodiment, the pipe comprises an alloy steel composition having between 4 to 12% Cr. In another embodiment, the pipe comprises an alloy steel composition having chemical requirements as specified according to any of ASTM A-335 and ASTM A-387.

In one aspect, the invention relates to a method for making an as-welded steel pipe for use in a CO2 corrosion environment. The method comprises: forming a cast steel slab, the steel having as components in weight: up to 0.35% of C; from 0.50 to 3.5% Si; up to 0.15% Mo; up to 1.35% Mn; up to 5% Al; one or more elements selected from Cr, Cu, Ni, and Cr in an amount of up to 0.4% each; a total concentration of Cr, Cu, Mo, Ni, and V of up to 1%; balance of Fe and unavoidable impurities; heating the steel slab to a temperature in excess of 2000° F.; rolling a heated steel slab in a rolling mill to obtain a skelp having a desired thickness; forming the skelp into a pipe having two side edges positioned in contact with one another; and welding the two side edges together to form an as-welded pipe. The as-welded pipe complies with at least one of ASTM and API standards with respect to manufacture, dimensions and weight, mechanical properties, testing, and certification. The pipe upon exposure to formation water and under CO₂ partial pressure of 0.5 MPa at a temperature of 40° C., the pipe has a corrosion rate of less than 40 mpy.

In one aspect, the invention relates to a method for making an as-welded steel pipe for use in a CO₂ corrosion environment. The method comprises the steps: forming a cast steel slab, the steel having chemical requirements as specified according to any of ASTM A106, ASTM A36, and API X65 standard and modified by adding at least 0.25% Si to the Si chemical requirements specified in the stardard; heating the steel slab to a temperature in excess of 2000° F.; rolling a heated steel slab in a rolling mill to obtain a skelp having a desired thickness; forming the skelp into a pipe having two side edges positioned in contact with one another; and welding the two side edges together to form an as-welded pipe; wherein the as-welded pipe complies to any of the standard with respect to manufacture, dimensions and weight, mechanical properties, testing, and certification; and upon exposure to formation water and under CO₂ partial pressure of 0.5 MPa at a temperature of 40° C., the pipe has a corrosion rate of less than 15 mpy.

In yet another aspect, the invention relates to a method for making a seamless steel pipe for use in a CO₂ corrosion environment. In the method, first a billet is formed, the billet having as components in weight: up to 0.35% of C; from 0.50 to 3.5% Si; up to 0.15% Mo; up to 1.35% Mn; up to 5% Al; one or more elements selected from Cr, Cu, and Ni in an amount of up to 0.4% each; a total concentration of Cr, Cu, Mo, Ni, and V of up to 1%; balance of Fe and unavoidable impurities. In the subsequent steps, the billet is subjected to a piercing operation to form a hollow shell; the hollow shell is then rolled forming the seamless steel pipe. The pipe upon exposure to formation water and under CO₂ partial pressure of 0.5 MPa at a temperature of 40° C., has a corrosion rate of less than 40 mpy.

### DESCRIPTION

The following terms will be used throughout the specification and will have the following meanings unless otherwise indicated.

“CO₂-containing environments” may be used interchangeably with “CO₂ corrosion environments,” in one embodiment referring to environments containing CO₂ and other contaminants such as organic acids, including but not limited to acetic acid, formic acid, propionic acid, etc., which increase the corrosivity due to the presence of CO₂, whether or not the sulfur species are present, with a pH of 3-6. In one embodiment, “CO₂-containing environments” refers to environments wherein the CO₂ partial pressure is at least 0.2 barg (2.8 psi or 0.20 bar) for a mild corrosive environment. In another embodiment, a CO₂ partial pressure of at least 28 psi (2 barg or 2 bar) for an aggressive environment. In yet another embodiment, “CO₂-containing environments” refers to a corrosive environment with gaseous mixtures of carbon dioxide and hydrogen sulfide, e.g., an oil well application, CO₂ corrosion dominating region and a CO₂/H₂S ratio of at least 200, or a mixed CO₂/H₂S corrosion dominance with a CO₂/H₂S ratio between 0.1 and 200.

“mpy” means mil per year in terms of corrosion rate (1 mpy=0.0254 mm/year=25.4 micro-m/year). The corrosion rate is computed based on metal loss of mm/y=87.6×(W/DAT), wherein W is weight loss in milligrams; D is the metal density in g/cm³; A is the area of sample; and T is exposure time of the sample in corrosive medium in hours. When used to indicate the corrosion of equipment, “mpy” refers to the average corrosion rate across the equipment and affecting the thickness of the equipment. For example, a 3″ Schedule 80 pipe having a corrosion rate of 12.2 mpy would produce an average thickness of 0.08″ after 18 years in service, with some sections of the pipe with less than or more than 0.08″ thick.

“CE” refers to “carbon equivalent,” which is an empirical measure of weldability in steels, used to guide the alloying/alloy selection if post-weld heat treatment needs to be avoided due to cost considerations. CE (in %) is computed as follows:

CE=% C+(% Mn+% Si)/6+(% Cr+% Mo+% V)/5+(% Ni+% Cu)/15

“Preheat treatment” refers to a process where the work piece, e.g., a pipe, is preheated prior to welding to a temperature of about 200-700° F., especially with steel compositions with a CE of greater than 0.45, to prevent the potential for cracking in the heat affected zones of flame cut edges and/or welds.

“Post weld heat treatment” or “PWHT” refers to a process especially for steel compositions with a CE of>0.63, in which a work piece is heated after welding to a temperature below the lower transformation temperature at a controlled rate for a specific amount of time (e.g., 1 hour per inch of thickness, 1 hr minimum), then cooling at a controlled rate, resulting in a modification of both the microstructure of the weld metal as well as the heat affected zone.

“Structural equipment” refers to piping systems, well heads, heat exchangers, and the like. A reference to any of structural equipment, pipes, piping systems, etc., also includes mechanical couplings for joining the structural equipment, e.g., fluid control components such as valves, valve stems, pumps, pump shafts, reducers, strainers, restrictors, pressure regulators and the like, as well as pipe stock, pipe fittings such as elbows, caps, tees, and the like. A reference to pipes also includes tubing.

“Free of chromium,” “essentially free of chromium” or “substantially free of chromium” means that in production of the steel composition, no chromium Cr will be deliberately added. Traces chromium can be present. Generally, however, the amount of chromium if any is less than 0.01 wt. %.

“Steel” refers to iron to which between 0.02 to 1.7% carbon has been added (http://www.newworldencyclopedia.org/entry/Alloy).

“Alloy steel” refers to steel that is alloyed with a variety of elements in total amounts between 1.0% and 50% by weight to improve its mechanical properties.

“Low alloy steel” refers to steel that is alloyed with a variety of elements in total amounts between 1.0% and 8% by weight.

“Silicon steel,” also known as “electrical steel” or “relay steel,” refers to a steel containing silicon of up to 6.5% (http://en.wikipedia.org/wiki/Electrical_steel).

“Formation water” or “produced water” refers to the layer of water that lies under the hydrocarbons. For the purpose of corrosion measurements, formation water has a concentration of 17,000 mg/l Na⁺, 1000 mg/l K⁺, 140 mg/l Ca²⁺, 100 mg/l Mg²⁺, 28,000 mg/l Cl⁻, 1300 mg/l SO₄²⁻, 1500 HCO₃⁻, and 100 mg/l CO₃²⁻.

Silicon steel has been used in the past primarily for electrical applications (thus the name “electrical steel”) and electromechanical devices such as relays, solenoids, transformers, electrical motors, fluorescent lamp ballasts, electricity meters, hermetic motors for refrigerators, and the like. These applications require materials with high electrical resistivity, high permeability, good magnetic properties in all directions—and a low cost. Resistivity property, which is low in iron, increases markedly with the addition of silicon.

Carbon steel has been widely used in the oil and gas industry for exploration and production applications such as gas/condensate pipelines, downhole tubulars, etc., as long as the conditions are not too corrosive. For corrosive conditions, alloy steels are used, which are expensive and require cost/care in fabrication primarily due to welding issues such as the need for post weld heat treatment after welds are made. In some cases, particularly at lower temperatures, corrosion inhibitors are used to help mitigate the corrosion in carbon steel as well as alloy steels.

Commercial grades of carbon steel typically contain less than 0.2% Si. In one aspect, the invention relates to specifically adding silicon to carbon steel to enhance the corrosion resistant properties, e.g., using a Si-modified carbon steel or silicon steel as structural equipment in CO₂ containing environments. The invention also relates to new alloy compositions with a low Cr concentration, by adding Si for a concentration of 0.5 to 3.5 wt. %, to improve corrosion resistant properties in CO₂ corrosion environments. In another aspect, the invention also relates to the addition of silicon to welding consumables (e.g., electrodes, etc.) used in the welding of structural equipment in CO₂ containing environments, for a concentration of 0.5 to 3.5 wt. % Si. Si is essentially the same cost as iron used as the basis for carbon steel, thus the increase in material cost is insignificant.

In one embodiment, the structural equipment with increased CO₂ corrosion resistance is a tubular product for use in CO₂ corrosion environments, e.g., as a drill pipe, a line pipe, well casing for lining an oil or gas well to enable extraction of the oil or gas therefrom, down hole tubulars and ancillary equipment, pipes and tubing for drilling, production and transport from offshore wells and deep wells, from deep wells to the surface, etc., referred generally as “pipe.”

Compositions of the Structural Equipment: The equipment for use in CO₂ corrosion environments can be constructed out of a steel composition without the need for high levels of alloying elements such as Cr, Mo, and Ni in the prior art, and with less than 12% Cr, less than 5% Ni, and less than 5% Mo. Depending on the applications, the equipment for use in CO₂ corrosion environments can be constructed partially or fully out of silicon steel type compositions (by modifying commercial grade carbon steel with the addition of Si), or alloy steel compositions with less than 12% Cr and modified with the addition of Si.

In one embodiment, the composition is a modified carbon steel with the modification being a sufficient amount of Si for the Si content to be in the range of 0.30-3.5 wt. %, thus providing the corrosion-resistant characteristics needed for CO₂ corrosion environments. In one embodiment, the composition is a modification of carbon steel standard being widely used in for various applications, e.g., ASTM A36 for carbon steel pipes; ASTM A106 is for high temperature service; ASTM A537 for carbon steel plates for pressure vessels, API L80 carbon steel for casing pipes, etc. Carbon steel is widely used in production and exploration operations, as the material is suitable for welding, bending, flanging and similar forming operations.

In one embodiment, the Si addition is at least 0.25 wt. % above the specified Si content for a Si level of up to 3.5 wt. %. In one embodiment, the Si addition is sufficient for a Si level of above 0.30% but sufficiently small enough for little or no impact on fabrication with a CE of 0.45 or less, for the material to weld just as conventional carbon steel. In another embodiment, the Si level is above 0.3% but sufficient high enough for the desired corrosion resistance rate, and modest fabrication impact with a CE of >0.45 but less than 0.63. For this CE range, preheat is needed prior to welding but no PWHT. In yet another embodiment with higher levels of Si and optionally with the addition of Cr for substantially better corrosion resistance protection, fabrication requirement as in the prior art with PWHT but for a much less expensive material than the conventional chrome alloys of the prior art.

In one embodiment, the equipment comprises a carbon steel composition having components in weight % of: up to 0.35% of C; from 0.50 to 3.5% Si; up to 0.15% Mo; up to 1.35% Mn; up to 5% Al; one or more elements selected from Cr, Cu, Ni, and Cr in an amount of less than 0.4% each; and a total concentration of Cr, Cu, Mo, Ni, and V of up to 1%. In another embodiment, the carbon steel compositions are as shown in Table 1 in wt. %, which compositions are modifications of ASTM/API grades with the addition of Si. Standard ASTM/API Si levels are also included for comparative purpose.

TABLE 1

| Compo- | Modified | Modified | Modified | Modified | Modified |
|---|---|---|---|---|---|
| nent | ASTM | ASTM | API | ASTM | API 5CT |
| wt. % | A106 | A36 | 5L X65 | A537 | L80 |
| Fe | bal | bal | bal | bal | bal |
| C max | 0.35* | 0.26* | 0.28* | 0.24 | 0.27 |
| Si | 0.3-3.5 | 0.3-3.5 | 0.3-3.5 | 0.3-3.5 | 0.3-3.5 |
| Mo | 0.15 max | — | — | — | 0.14 |
| Cr | 0.4 max | — | 0.011 | — | 0.04 |
| Mn max | 0.29-1.06** | 1.35** | 1.35** | 1.46** | 1.30 |
| P max | 0.035 | 0.04 | 0.03 | 0.035 | 0.009 |
| S max | 0.035 | 0.05 | 0.03 | 0.035 | 0.002 |
| Cu max | 0.4 | 0.20 [symbol] | — | 0.35 | — |
| Ni max | 0.4 | — | — | .25*** | — |
| V max | 0.08 | — | — | — | — |
| Al max | 5.0 ε | 5.0 ε | 5.0 ε | 5.0 ε | — |
| Cr, Cu, | <1 wt. % | — | — | — | — |
| Mo, Ni, | | | | | |
| V total | | | | | |
| Si level | <0.20 [symbol] | <0.4 Δ | <0.40-0.55 | 0.15-0.5 | 0.13 |
| per | | | | | |
| standard | | | | | |

ε The standards do not specify limit for Al. [symbol]
Although ASTM A106 does not specify a max limit for Si, prior art concentrations for structural equipment according to ASTM 106 specifications has Si content of <0.2 wt %. [symbol]
minimum Cu % when copper steel is specified.
* and **For each reduction of 0.01% below the maximum C level, an increase in Mn of 0.05% is permitted up to 1.35% (up to 2% is permitted for certain grades of API X65). For ASTM A537, Mn level may go up to 1.6% if CE is less than 0.57.
***Ni level may go up to 0.5% if CE is less than 0.57.
Δ Si content of 0.15 to 0.40 is required for shapes with >3″ thick flanges.

In one embodiment, the carbon steel composition modified with Si addition is essentially free of Cr, while still providing the equipment with excellent corrosion resistance in CO2 corrosion environments comparable to compositions in the prior art with higher Cr levels, e.g., at least 1%. In another embodiment, the Si-modified carbon steel composition has a Cr concentration of less than 0.4%. In yet another embodiment, the Al concentration is 2% or less.

In another embodiment, the equipment for use in CO₂ corrosion environment comprises a modified alloy steel from a standard specification, with the modification to the standard chemical requirements being the addition of Si for the alloy steel to have a Si concentration ranging from 0.5 to 3.5 wt. %. The alloy steel in one embodiment is according to any of ASTM and/or API standards for structural equipment, including but not limited to A387, “Standard Specification for Pressure Vessel Plates, Alloy Steel, Chromium Molybdenum,” and ASTM A335, “Standard Specification for Seamless Ferritic Alloy-Steel Pipe for High-Temperature Service.” Theses specifications cover Cr-alloy steel intended for elevated temperature service. Examples include but are not limited to ASTM/ASME A335/SA335 P2, P5, P11, P22, P23, P5, P91, and P92.

In one embodiment, the modified alloy steel is by modifying any of 3-Cr, 5-Cr, 9-Cr, 12-Cr grades in ASTM A335, ASTM A691, and ASTM A387, with the addition of

Si to the Cr alloy steel being sufficient for the composition to have a Si content ranging from 0.5 to 3.5 wt. % Si. The addition of Si provides the alloy steel the corrosion resistant characteristics of an alloy steel having a higher Cr content. For example, the addition of 0.25 to 1.5% Si to a 5-Cr alloy provides the 5-Cr alloy with the corrosion resistant characteristics of a 9-Cr alloy; and the addition of 0.25 to 1.5% Si to a 9-Cr alloy provides the 9-Cr alloy with the corrosion resistant characteristics of a 12.5 Cr SS (or SS Grade 440 with 0.5% C, 11.5-13.5% Cr, >0.75% Ni, <1% Mn, <1% Si, 0.04% P, <0.03% S, balance Fe). Providing the CO₂ corrosion characteristics means that the corrosion rate of the Si-modified alloy steel is within 15% (lower or higher) of the comparative corrosion rate in mpy.

In one embodiment, the equipment comprises an alloy steel composition having components in weight % of: up to 0.35% of C; from 0.50 to 3.5% Si; up to 1.2% Mo; up to 1.35% Mn; up to 5% Al; and from 4.0 to 12.0% Cr. In another embodiment, the alloy steel composition is a modified alloy steel grade according to ASTM standards as shown in Table 2, with the modification being a higher Si concentration than specified under the standards. The Si concentration as specified in the standards is also included for comparative purpose.

TABLE 2

| Component | | | | | |
|---|---|---|---|---|---|
| wt. %/ | | | | | |
| Si-modified | A335 | A335 | A335 | A387 | 3% Cr |
| Grade | P-5 | P-5b | P-122 | Grade 9 | Steel |
| C | 0.15 max | 0.15 max | 0.15 max | 0.15 max | 0.15 max |
| Mn | .30-.60 | 30-.60 | 0.7 max | 0.30-0.60 | 0.55 |
| P, max | 0.025 | 0.025 | 0.02 | 0.02 | 0.02 |
| S, max | 0.025 | 0.025 | 0.01 | 0.025 | 0.025 |
| Si | 0.75-3.5 | 1.25-3.50 | 0.75-3.5 | 1.25-3.5 | 0.75-3.5 |
| Cr | 4.0-6.0 | 4.0-6.0 | 10.0-11.5 | 8.0-10.0 | 3 |
| Mo | 0.45-0.65 | 0.45-0.65 | 0.25-0.60 | 0.9-1.10 | 0.15 |
| comparative | 0.50 | 1.0-2.0 | 0.50 | 1.0 | 0.20 |
| Si per | | | | | |
| standard | | | | | |

In one embodiment, the corrosion resistant composition is a modification of a high-strength steel composition as disclosed in US Patent Publication No. 2007/0267110, included herein by reference in its entirety, with the modification being an increase in the Si content from the specified level of 0.26 to 0.34 wt. % to at least 0.5 wt. %, and preferably up to 2.5 wt. %.

In another embodiment, the corrosion resistant composition is a modification of the low alloy steel with high yield strength and high sulfide stress cracking resistant (SSC-resistant) as disclosed in US Patent Publication No. 2011/0315276, the disclosure included herein by reference in its entirety. The modification comprises adding Si to the specified Si level of 0.5%, for a level of 0.75 to 2.5% Si, for a composition with 0.3-0.5% C; 0.75 to 2.5% Si; 0.1 to 1% Mn; less than 0.03% P; less than 0.005% S; 0.3 to 1.5% Cr; 1 to 1.5% Mo; 0.01 to 0.1% Al; 0.03 to 0.06% V; 0.04 to 0.15% Nb; up to 0.015% Ti; and the balance being Fe. In one embodiment, the Al level is increased to a level of 0.5 to 5%.

The Si-modified composition in one embodiment is greater than 0.3% but sufficiently low enough for a CE of 0.45 or less for better weldability, avoiding the need for preheat before welding. The Si-modified composition in one embodiment contains less than 1.5 wt. % Si and with a CE of 0.63 or less, as higher the CE the higher the hardness in the weld seam after welding. The maximum hardness allowed in a pipe after welding is approximately 250 Vickers, which corresponds to a CE of 0.6. Any weldments with a CE higher than 0.6 require a post weld heat treatment (PWHT) before the equipment is put into service.

In one embodiment, the Si-modified composition contains 0.5 to 3.5 wt. % Si and with a CE greater than 0.63, which requires PWHT. PWHT is also employed in embodiments wherein the composition has a microhardness which exceeds the API spec limit of 250 HV for Si levels >1.3%, PWHT helps reduce the hardness to within spec.

In one embodiment, the Si-modified composition further contains 0.2 to 5% Al. In another embodiment, the Al addition is kept below 2% to minimize problems with discontinuities in the coating (e.g., bare spots).

Method for Forming Equipment for CO₂ corrosion Environments: In the form of a pipe, the structural equipment is manufactured according to the specifications as required in the prevailing industry standards for the application with respect to manufacture, dimensions and weight, workmanship, finish, appearance, properties and product testing, certification, and product analysis; employing a carbon steel or alloy steel composition with a

Si content of at least 0.50 to 3.5 wt. % to provide the necessary corrosion protection for the equipment. Industry standards with respect to physical dimensions include but are not limited to wall thickness, inside and outside diameters, external surface, etc. Standards with respect to properties and product testing include but are not limited to metallurgical properties, mechanical properties, etc., to assure the performance, safety, protection, and certification required for the application.

In another embodiment, the pipe is manufactured according to the prevailing industry standards according to at least one of API (such as API Spec 5L 4^{th} edition), ASTM, DIN, ISO, NFA, EN, EEMUA, DNV, GOST, and modified with respect to the chemical composition requirements with the addition of Si of at least 0.25 wt. % to the Si concentration specified in the chemical requirements, for a Si concentration of 0.50 to 3.5 wt. %. In one embodiment, the pipe with the Si-modified composition is manufactured according to ASTM A106 seamless carbon steel pipe for high-temperature service tools. In another embodiment, the standard is ASTM A53 Steel Pipe Grade Supplies for the oil and gas industries.

The structural equipment in the form of a pipe product can be: welded pipe formed from hot-rolled steel (skelp) which has been fashioned into a tube, having a straight longitudinal weld (also referred to as “as-welded” or “as-rolled” pipe); and seamless pipe produced by subjecting a steel billet to a piercing operation followed by a rolling or stretch-forming operation (also referred to as “as-formed” pipe).

In one embodiment to form a welded pipe, a cast steel slab comprising the composition with a Si content ranging from 0.5 to 3.5 wt. % Si is formed. The steel slab is heated to a temperature in excess of 2000° F., e.g., approximately 2300° F., then hot-rolled at a temperature of approximately 1500° F. to obtain a skelp having a desired thickness. The skelp is slit or sized longitudinally to a width corresponding to the desired circumference of the pipe. The sized skelp is passed progressively through a series of rolls to form a round tube with two edges. The edges are then welded together using welding processes known in the art, e.g., ERW.

In one embodiment, the structural equipment is constructed from Si-modified compositions with a concentration of 0.50 to 1.5 wt. % Si, and with a CE of less than 0.45, no preheat is required. In another embodiment with a CE of less than 0.63, PWHT is not required as CE diminishes, weldability improves. In another embodiment, the Si concentration is between 0.5 to 2.5 wt. % but the CE is >0.63, hence requiring PWHT. In one embodiment of PWHT, the as-welded or as formed steel equipment is heated above the A₃ temperature (into the austenite phase field) to approximately 1650 to 1750° F., water quenched to ambient then tempered by reheating, e.g., from 900 to 1300° F. In one embodiment of a Si-modified carbon steel composition, the material chemistry is balanced such that after welding with no preheat nor post weld heat treatment (PWHT), the resulting hardness in the material heat affected zone of the equipment does not exceed 248 Vickers hardness (HV10).

Performance of Equipment in Corrosive Environments Structural equipment employing the Si-modified composition is particular suitable for use in CO₂ corrosion environments such as gas and oil explorations.

In one embodiment, structural equipment constructed out of a composition with an added Si concentration for a Si concentration of at least 1 wt. % experiences a corrosion rate of at least 25% less than the corrosion rate of equipment constructed out of the same compositions without the added Si. In another embodiment, the corrosion rate is at least 50% less than the corrosion rate of a similar composition without the addition of at least 0.25% Si.

In one embodiment of a carbon steel composition with a Si content between 0.50 to 2.5 wt. %, the equipment shows a corrosion rate of less than 40 mpy upon exposure to formation water and under CO₂ partial pressure of 0.5 MPa at a temperature of 40° C. In one embodiment of a carbon steel composition containing between 1 and 2.5 wt. % Si, the corrosion rate is less than 25 mpy.

In one embodiment of a modified 5-Cr alloy steel composition containing between 0.5 and 2.5 wt. % Si, the corrosion rate is less than 25 mpy upon exposure to formation water and under CO₂ partial pressure of 0.5 MPa at a temperature of 40° C. In another embodiment with a 9-Cr alloy steel composition containing between 0.3 and 2.5 wt. % Si, the corrosion rate is less than 15 mpy.

Besides an improved corrosion performance, the equipment also shows a formation of a protective coating (scale), with a scale mass change of up to +1 mg/cm² for a Si concentration between 1 to 3.5 wt. %. For prior art equipment employing carbon steel, a negative value of mass scale is typically observed indicating spalling of the scale in a corrosive environment.

### EXAMPLES

The following illustrative examples are intended to be non-limiting.

### Example 1

A number of coupons were provided, including: a) type A 106 carbon steel as comparables and a) Si-modified type A 106 carbon steel with sufficient Si added for concentrations of 1.5 w. %. The coupons were of the same size and generally ¾ to 2″ long, ½ to ¾″ wide, and 1/16 to ⅛″ thick. The coupons were immersed for 4 weeks in heated glass cells at room temperature containing water with CO₂ bubbling through for a pH of about 4. After removal from solution, the coupons were inspected visually. The comparable carbon steel coupons showed pitting corrosion vs. the Si-modified coupons which were not very much affected by the CO₂ corrosion.

### Example 2

Coupons of samples including: a) 3% Cr steel as comparable examples; and a) Si-modified API X65 carbon steel with sufficient Si added for concentrations of 1, 1.5, 2.0, and 2.5 wt %. The coupons are of the same size and generally 3/4 to 2″ long, ½ to ¾″ wide, and 1/16 to ⅛″ thick. The coupons are put into autoclave. Electrolyte solution is made to simulate formation water drawn from oil and gas fields with about 17,000 mg/l Na⁺, 1000 mg/l K⁺, 140 mg/l Ca²⁺, 100 mg/l Mg²⁺, 28,000 mg/l Cl⁻, 1300 mg/l SO₄²⁻, 1500 HCO₃⁻, and 100 mg/l CO₃²⁻. Tests are carried out at a temperature ranging from 40° C. to 100° C., with CO₂ partial pressure of 0.5 to 1.5 MPa and a flow rate of 1 m/s. The test is for 1 week.

After removal from solution, the samples are weighed and examined by optical and scanning electron microscopy for evidence of corrosion and corrosion product films. Energy dispersive X-ray (EDX) analyses are employed to determine qualitatively the compositions and corrosion product films. The samples are also examined for morphology of the corrosion attack at different locations of the samples, as well as the morphology and thickness of the surface films as a function of the location on the sample.

It is anticipated that the Si-modified API X65 steel coupon with a Si content of 1-2.5 wt. % to have a corrosion rate less than or comparable to the rate of 3% Cr steel, for a corrosion rate of less than 25 mpy at 40° C. and 0.5 MPa CO₂ partial pressure, and a rate of less than 40 mpy at 60° C. and 1 MPa CO₂ partial pressure.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

This written description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A corrosion resistant pipe, comprising:
a carbon steel composition based on weight: up to 0.35% of C; from 0.50 to 3.5% Si; up to 0.15% Mo; up to 1.35% Mn; up to 5% Al; one or more elements selected from Cr, Cu, and Ni in an amount of less than 0.4% each; a total concentration of Cr, Cu, Mo, Ni, and V of up to 1%; balance of Fe and unavoidable impurities;
wherein the pipe complies to at least one of ASTM and API standards with respect to manufacture, dimensions and weight, mechanical properties, testing, and certification; and
wherein the pipe is for oil and gas drilling and exploration in CO₂-containing environments, and wherein the pipe has a corrosion rate of less than 40 mpy upon exposure to formation water and under CO₂ partial pressure of 0.5 MPa at a temperature of 40° C.

2. The corrosion resistant pipe of claim 1, wherein the pipe comprises a carbon steel composition essentially free of Cr.

3. The corrosion resistant pipe of claim 1, wherein the pipe comprises a carbon steel composition having 0.3% to 1.5% Si by weight.

4. The corrosion resistant pipe of claim 1, wherein the pipe comprises a carbon steel composition having a CE of less than 0.45.

5. The corrosion resistant pipe of claim 4, wherein the pipe comprises a carbon steel composition having a CE of greater than 0.45 and less than 0.63.

6. The corrosion resistant pipe of claim 1, wherein the pipe comprises a carbon steel composition having a CE greater than 0.63.

7. The corrosion resistant pipe of claim 1, wherein the pipe comprises a carbon steel composition having an Al content ranging from 0.2 to 2% by weight.

8. The corrosion resistant pipe of claim 1, wherein the pipe comprises a carbon steel composition having chemical requirements as specified according to any of ASTM A106, ASTM A36, API L 80, and API X65 carbon steel standards, modified by adding at least 0.25% Si to the chemical requirements specified in the stardard.

9. The corrosion resistant pipe of claim 8, wherein the chemical requirements are modified by adding a sufficient amount of Si to the chemical requirements specified in the stardard for a Si content ranging from 1 to 2.5% by weight.

10. The corrosion resistant pipe of claim 1, wherein the pipe has a corrosion rate of less than 25 mpy upon exposure to formation water and under CO₂ partial pressure of 0.5 MPa at a temperature of 40° C.

11. A corrosion resistant pipe, comprising:
a steel composition having chemical requirements as specified according to at least one of ASTM and API standards, modified by adding at least 0.05% Si to the chemical requirements for a Si content ranging from 0.30 to 3.5% by weight,
wherein the pipe complies to the at least one of ASTM and API standards with respect to manufacture, dimensions and weight, mechanical properties, testing, and certification;
wherein the pipe is for use in CO2 corrosion environments for drilling and exploration for oil and gas; and
wherein the pipe has a corrosion rate of less than 40 mpy upon exposure to formation water and under CO₂ partial pressure of 0.5 MPa at a temperature of 40° C.

12. The corrosion resistant pipe of claim 11, wherein the pipe comprises a steel composition having between 4 to 12% Cr.

13. The corrosion resistant pipe of claim 11, wherein the pipe comprises a steel composition having chemical requirements as specified according to any of ASTM A-335 and ASTM A-387 with a Cr content of less than 10%.

14. The corrosion resistant pipe of claim 11, wherein the pipe comprises a steel composition having a CE of less than 0.45.

15. The corrosion resistant pipe of claim 11, wherein the pipe comprises a steel composition containing from 0.5 to 2% Al.

16. A method for forming a corrosion resistant pipe for use in oil and gas drilling and exploration in CO₂-containing environments, the method comprising:
providing a steel composition having chemical requirements as specified according to any of ASTM and API standards, modified by adding at least 0.25% Si to the chemical requirements of Si, for a Si content ranging from 0.30 to 3.5% by weight;
forming a pipe from the steel composition such that the stsructural equipment complies to at least one of the ASTM standards, API standards with respect to manufacture, dimensions and weight, mechanical properties, testing, and certification of the structural equipment;
wherein the pipe is suitable for use in CO2 corrosion environments, having a corrosion rate of less than 40 mpy upon exposure to formation water and under CO₂ partial pressure of 0.5 MPa at a temperature of 40° C.

17. The method of claim 16, for forming a pipe for high temperature applications complying to at least one of ASTM A106, ASTM A36, and API X65 standards with respect to manufacture, dimensions and weight, mechanical properties, testing, and certification of the pipe.

18. The method of claim 16, wherein providing a steel composition having chemical requirements as specified according to any of ASTM and API standards comprises
providing an alloy steel composition having Si chemical requirements according to any of ASTM A335 and A287 standard and modified by adding at least 0.25% Si to the Si chemical requirements specified in the stardard.

19. The method of claim 16, wherein providing a steel composition having chemical requirements as specified according to any of ASTM and API standards comprises
providing an alloy steel composition having chemical requirements as specified according to ASTM A335 Grade P-5 standard with 4.0 to 6.0% Cr, modified by adding at least 0.25% Si to the chemical requirements for a Si content ranging from 0.50 to 2.5% by weight.

20. The method of claim 16, wherein providing a steel composition having chemical requirements as specified according to any of ASTM and API standards comprises
providing a steel composition having chemical requirements as specified according to any of ASTM and API standards, modified by adding at least 0.25% Si to the chemical requirements of Si, for a compostion based on weight: up to 0.35% of C; from 0.50 to 3.5% Si; up to 0.15% Mo; up to 1.35% Mn; up to 5% Al; one or more elements selected from Cr, Cu, Ni, and Cr in an amount of less than 0.4% each; a total concentration of Cr, Cu, Mo, Ni, and V of up to 1%; balance of Fe and unavoidable impurities.
